(19) United States
(12) Patent Application Publication
(10) Pub. No.: US 2026/0231979 A1
(43) Pub. Date: Aug. 13, 2026

(54) FOOD PRODUCT AND METHOD FOR PRODUCING THEREOF

(71) Applicant: Hailia Nordic Oy, Parainen (FI)

(72) Inventors: Otto KAUKONEN, Parainen (FI); Michaela LINDSTRÖM, Parainen (FI)

(21) Appl. No.: 19/153,869

(22) PCT Filed: Feb. 7, 2024
(86) PCT No.: PCT/FI2024/050047

§ 371 Date: Aug. 5, 2025

(30) Foreign Application Priority Data
Feb. 7, 2023 (FI) 20235118

(51) Int. Cl. A23J 3/22; A23L 17/00

(52) U.S. Cl. CPC A23J 3/22; A23L 17/00

(57) ABSTRACT

It is disclosed a sustainable method for producing a textur-ized fish product, comprising the steps of: providing a fish ma-terial; optionally providing a plant-based food material; de-riving a fish feedstock from the fish material; subjecting the fish feedstock to a texturizing step at most 100° C. to provide a texturized fish product having a protein content of about 10% to about 25% based on the weight of the texturized fish prod-uct.

### FIELD OF THE INVENTION

The present invention relates to a food product and a method for producing thereof. More particularly, the invention relates to sustainable method for producing a texturized fish product.

### BACKGROUND OF THE INVENTION

WO 01/35766 A1 discloses a meat emulsion product having meat-like appearance and texture and a method for making the same. The method involves forming a meat emulsion containing protein and fat, comminuting and heating the emulsion to a temperature of at least 132° C., introducing the emulsion into a processing zone where it is subjected to a pressure of at least 100 psi, and discharging the emulsion from the zone.

There is globally a high need for providing methods for producing food products for consumers in an effective and sustainable way, especially from currently underutilized and sustainable protein sources, such as small size forage fish and fish processing edible side streams. Despite being an ecologically sustainable protein source with excellent nutritional quality, small size fish species including forage fish, growing naturally without the need of production resources, is commonly not used in food production due to the lack of effective and sustainable production method for cleaning and filleting. If used as whole or gutted, the presence of skin, scales and fishbones disrupts the mouthfeel which decreases the consumer acceptance of final products, especially among younger consumers. The same dilemma applies also to the edible side products from production of large fish species (e.g. filleting). If these fish materials are used as grinded or emulsified, the structure and mouthfeel of these food products (e.g. balls or patties) do not meet the consumer expectations of a high quality fish product.

### BRIEF DESCRIPTION OF THE INVENTION

It has now been found that an appealing food product for human consumption can be effectively produced from undervalued fish species including forage fish growing naturally without the need of production resources, or undervalued parts of a fish material, such as by-products or side streams from traditional processing of larger fish species, without relevant side streams or waste. More particularly, it was surprisingly found that a fish material of small size fish species, or side streams from traditional fish processing, containing also skin, scales, heads, fishbones and fins and having a low protein content can be texturized to provide a texturized fish product having a desired texture and mouthfeel. Surprisingly texturizing with such a low protein content was found feasible by achieving a low internal temperature in fish material prior to texturizing process. Typically, in order to have desired structure in texturized food product, a relatively high protein content and preferably low carbohydrate content in the matrix is needed.

The texturized food product of the invention has satisfactory organoleptic properties, such as appealing taste and good mouthfeel, and exhibits a cooked fish meat-like texture or cooked fish fillet-like texture, and appearance containing areas of parallel longitudinal fish meat strips.

The invention thus provides a sustainable and effective method for producing novel and valuable consumer acceptable food products from a low value fish material, e.g., small size fish as whole or gutted, and/or undervalued parts of large fish which is/are typically used in the manufacture of animal feed.

An object of the invention is to provide a method for producing a texturized fish product. The method of invention does not employ an extrusion process for texturizing.

Another aspect of the invention is to provide a texturized fish product comprising a texturized fish material and having a protein content of about 10% to about 25% based on the weight of the texturized fish product.

### BRIEF DESCRIPTION OF THE DRAWINGS

FIG. 1 is a photograph of the texturized fish product of the invention produced in example 1.

FIG. 2 is a photograph of another fish product of the invention illustrating the longitudinal and cross-sectional directions referred in the textural analyses of Example 3.

FIG. 3 is a photograph of the texturized fish product of the invention produced in example 4.

FIG. 4 is a photograph of the texturized fish product of the invention produced in example 5.

FIG. 5 is a photograph of the texturized fish product of the invention produced in example 6.

FIG. 6 is a photograph of the texturized fish product of the invention produced in example 7.

FIG. 7 shows photographs of the texturized fish products of the invention produced in example 8.

FIG. 8 is a photograph of the texturized fish product of the invention produced in example 9.

### DETAILED DESCRIPTION OF THE INVENTION

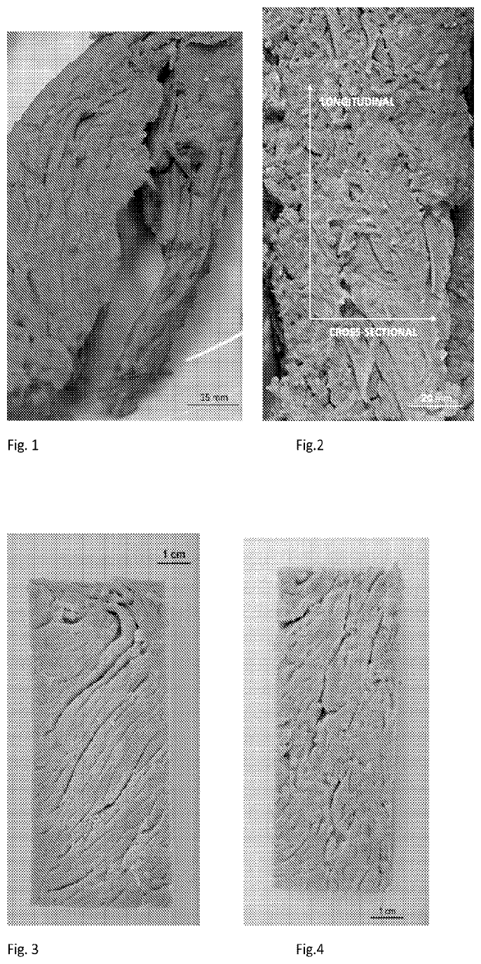

In the context of the present invention, the term “texturizing” means a restructuring process in which fish protein is rearranged and coagulated into cooked fish meat-like texture or cooked fish fillet-like texture. In particular, texturizing provides arrangement of fish meat in longitudinal parallel strips as shown in FIGS. 1-7, which creates an appearance and mouthfeel similar to cooked fish fillet. In other words, the method of the invention provides a texture of parallel longitudinal alignment of heat-coagulated fish meat filaments resembling the muscle fibrils of cooked fish fillet.

The term “texturizing” does not encompass an extrusion process.

The percentages of various ingredients mentioned in the present application are given on weight basis (w/w).

Any details of the embodiments or aspects disclosed herein with respect to a texturized fish product produced by the method of the invention apply to embodiments concerning the texturized fish product of the invention, even if not repeated here. Likewise, any details of the embodiments or aspects disclosed herein with respect to a texturized fish product of the invention apply to embodiments concerning the texturized fish product produced by the method of the invention, even if not repeated here.

In an aspect, the invention provides a method for producing a texturized fish product, comprising the steps of:
providing a fish material,
optionally providing a plant-based food material,
deriving a fish feedstock from the fish material,
subjecting the fish feedstock to a texturizing step at most 100° C. to provide a texturized fish product having a protein content of about 10% to about 25% based on the weight of the texturized fish product.

In the method, any fish species may be used as a fish material. In an embodiment, the method uses small pelagic fish, such as sill, mackerel, sardine, blue whitening, Baltic herring or other small size fish species, such as vendance, perch, ruffe, sprat and roach. In another embodiment, the fish material is commercially important larger fish species, such as salmonoids (e.g., Atlantic salmon, rainbow trout, whitefish), codfish, pollock, tuna, pangasius. In an embodiment, the fish material is whole fish. In another embodiment, the fish material is gutted fish comprising at least one of fish bones, skin, fins, heads and scale. In an embodiment, the fish material is by-product or side stream from traditional fish processing, such as gutting or filleting. The fish material may contain several different fish materials described above. In an embodiment, the fish material is frozen.

In an embodiment, the fish feedstock subjected to the texturizing step consists of a fish material whereby texturizing step provides a texturized fish material as a final texturized fish product. In another embodiment, the fish material is mixed with a plant-based food material to provide a homogenous fish feedstock which is subjected to a texturization step to provide a final texturized fish product. The plant-based food material beneficially stabilizes and facilitates the texturizing process and contributes to flavor and/or appearance of a texturized fish product. In an embodiment, the plant-based food material is selected from at least one of starch, cereal meals, fibers, root vegetable meals, legumes, algae and spices. In an embodiment, the plant-based food material is in powdered form. In an embodiment, the plant-based food material is gluten-free and free from soy protein.

In an embodiment, the fish feedstock contains at least 50% of a fish material. In another embodiment, the fish feedstock contains about 55% to about 90% of a fish material. In yet another embodiment, the fish feedstock contains about 65% to about 85% of a fish material. In still another embodiment, the fish feedstock contains about 55% to about 98% of a fish material. In a further embodiment, the fish feedstock contains about 75% to about 85% of a fish material. In a still further embodiment, the fish feedstock contains about 65% to about 90% of a fish material. In a still further embodiment, the fish feedstock contains about 70% to about 95% of a fish material.

In an embodiment, the fish feedstock contains a plant-based food material at most 50%. In another embodiment, the fish feedstock contains a plant-based food material of about 10% to about 45%. In yet another embodiment, the fish feedstock contains a plant-based food material of about 15% to about 35%. In still another embodiment, the fish feedstock contains a plant-based food material of about 2% to about 45%. In a further embodiment, the fish feedstock contains a plant-based food material of about 15% to about 25%. In a still further embodiment, the fish feedstock contains a plant-based food material of about 10% to about 35%. In a still further embodiment, the fish feedstock contains a plant-based food material of about 5% to about 30%.

In an embodiment, the fish feedstock has a dry matter content of about 20% to about 50%. In another embodiment, the dry matter content of the feedstock is about 30% to about 40%. In a further embodiment, the dry matter content of the feedstock is about 25% to about 60%.

In an embodiment, the fish feedstock is homogenized in a way that fishbones, skin, fins and scale do not deteriorate the mouthfeel after texturization.

In an embodiment, the temperature of the fish feedstock does not exceed 35° C. during the homogenization.

In an embodiment, the fish feedstock is deaerated prior to the texturizing step.

The texturizing step comprises heating a fish feedstock, which is in constant flow, between two heated surfaces. The distance between the heated surfaces may vary depending on the apparatus construction, desired process or product characteristics. The distance may be varied between about 0.5 cm to about 3 cm. In an embodiment, the flow may be generated by the movement of one or more of the heated surfaces. In another embodiment, the flow may be generated by the movement of the fish feedstock. In still another embodiment, the movement of the flow may be generated by both movements of the one or more of the heated surfaces and the fish feedstock. The speed of the flow of the fish feedstock and the speed of the movement of the heated surfaces may vary depending on the fish feedstock recipe and the desired outcome of the final product. During the heating, the fish feedstock is cooked in constant flow while alignment and coagulation of the proteins takes place. Simultaneously, the texture of the fish feedstock is transformed to a form displaying longitudinal parallel fish meat strips and cooked fish fillet-like appearance.

In an embodiment, the texturizing step is performed between about 0° C. (representing the internal temperature of the fish feedstock) in the beginning and about 95° C. (representing the internal temperature of the texturized fish product). In another embodiment, the texturizing step is performed between about 0° C. (representing the internal temperature of the fish feedstock) in the beginning and about 90° C. (representing the internal temperature of the texturized fish product). In yet another embodiment, the texturizing step is carried out between about 3° C. and about 85° C. In a further embodiment, the texturizing step is carried out between about 5° C. to about 75° C.

In an embodiment, the internal temperature of the fish feedstock subjected to the texturizing step is in the range of about 0° C. to about 35° C. In another embodiment, the internal temperature is about 0° C. to about 30° C. In yet another embodiment, the internal temperature is about 0° C. to about 25° C. In a further embodiment, the internal temperature of the fish feedstock is about 2° C. to about 15° C. In a still further embodiment, the internal temperature of the fish feedstock is about 3° C. to about 10° C. In a still further embodiment, the internal temperature of the fish feedstock is about 5° C. to about 13° C.

In an embodiment, the internal temperature of the texturized fish product discharged from the texturizing step is about 70° C. to about 95° C. In another embodiment, the internal temperature about 70° C. to about 90° C. In yet another embodiment, the internal temperature is about 75° C. to about 85° C.

During texturizing of the fish feedstock, the texture of the fish feedstock is transformed to a cooked fish meat-like texture or cooked fish fillet-like texture and mouthfeel using heat and mechanical energy on the fish feedstock. Transformation is predominantly directed to a protein portion of the fish material. During texturization, the fish protein is coagulated due to the heat treatment. Texturizing provides a texturized cooked fish product which exhibits a longitudinal parallel fish meat strips creating cooked fish fillet-like texture, mouthfeel and appearance.

The texturizing step is performed at an atmospheric pressure, i.e., the method of the invention does not involve an adjustment of the pressure.

The texturization step is typically accomplished for about 45 sec to about 55 sec. However, the residence time may vary depending on the type of apparatus used for texturization. The residence time may vary, e.g., depending on whether the texturization is performed on a laboratory scale apparatus or on an industrial scale apparatus.

The texturizing step is typically accomplished in an apparatus, in which the fish feedstock is fed through an opening in the centre of the apparatus between stationary discs which are heated. The fish feedstock is transported between the discs by means of rotating paddles radially outwards to the periphery of the apparatus and finally discharged. The texturizing step may be accomplished in an apparatus in which the fish feedstock is fed between any two heated surfaces, and the fish feedstock is conducted into constant flow while transported between the heated surfaces until the fish feedstock is cooked prior to discharge.

The texturization step in the method of the invention is not performed by extrusion.

In an embodiment, the protein content of the texturized fish product produced by the method of the invention is about 12% to about 20% based on the weight of the texturized fish product. In another embodiment, the protein content the texturized fish product is about 14% to about 17% based on the weight of the texturized fish product.

In an embodiment, the texturized fish product produced by the method of the invention has a protein content of about 25% to about 90% based on dry matter of the texturized fish product. In another embodiment, the protein content is about 30% to about 45% based on dry matter. In a further embodiment, the protein content is about 35% to about 90% based on dry matter of the texturized fish product. In another embodiment, the protein content of the texturized fish product produced by the method of the invention is about 40% to about 65% based on dry matter of the texturized fish product. In a further embodiment, the protein content of the texturized fish product produced by the method of the invention is about 50% to about 60% based on dry matter of the texturized fish product. When the fish feedstock containing a fish material does not comprise a plant-based food material, the protein content of the texturized fish product is typically about 70% to about 90% based on dry matter of the texturized fish product. When the fish feedstock containing a fish material further comprises a plant-based food material, the protein content of the texturized fish product is typically about 35% to about 65% based on dry matter of the texturized fish product.

In an embodiment, the texturized fish product produced by the method of the invention has a fish protein content of about 50% to about 100% based on the total protein content of the texturized fish product. In another embodiment, the fish protein content is about 60% to about 90%. In a further embodiment, the fish protein content is about 70% to about 80%.

In an embodiment, the texturized fish product produced by the method of the invention has a longitudinal tensile strength of about 3.5 kPa to about 10 kPa. In another embodiment, the longitudinal tensile strength is about 4.0 kPa to about 8.0 kPa.

In an embodiment, the texturized fish product produced by the method of the invention has a cross-sectional cutting force of about 2.0 N to about 5.0 N. In another embodiment, the cross-sectional cutting force is about 2.2 N to about 4.0 N.

The texturized fish product produced by the method of the invention may be further formulated to various fish food compositions comprising further ingredients and food additives. For example, the texturized fish may be shredded, sliced, cut, molded, coated, breaded, deep-fried, or frozen.

In another aspect, the invention provides a texturized fish product comprising a texturized fish material and having protein content of about 10% to about 25% based on the weight of the texturized fish product.

In an embodiment, the protein content of the texturized fish product of the invention is about 12% to about 20% based on the weight of the texturized fish product. In another embodiment, the protein content is about 14% to about 17%.

The fish material in the texturized fish product is whole fish, or gutted fish, or fish processing by-products comprising at least one of fish bones, skin, fins, heads, and scale.

In an embodiment, the texturized fish product of the invention contains at least 50% of a texturized fish material based on the weight of the texturized fish product. In another embodiment, the amount of a texturized fish material is about 55% to about 90%. In yet another embodiment, the amount is about 65% to about 85%. In a further embodiment, the amount is about 55% to about 98%. In a still further embodiment, the amount is about 75% to about 85%. In a still further embodiment, the amount is about 65% to about 90%. In a still further embodiment, the amount is about 70% to about 95%.

In an embodiment, the texturized fish product comprises a plant-based food material. The plant-based food material is selected from group comprising at least one of starch, cereal meals, fibers, root vegetable meals, legumes, algae and spices.

In an embodiment, the texturized fish product of the invention contains at most 50% of a plant-based food material based on the weight of the texturized fish product. In another embodiment, the amount of a plant-based food material is about 10% to about 45%. In a further embodiment, the amount of a plant-based food material is about 15% to about 35%. In a still further embodiment, the amount is about 2% to about 45%. In a still further embodiment, the amount is about 15% to about 25%. In a still further embodiment, the amount is about 10% to about 35%. In a still further embodiment, the amount is about 5% to about 30%.

The texturized fish product of the invention has a dry matter content of about 20% to about 50%. In another embodiment, the dry matter content of the texturized fish product is about 30% to about 40%. In a further embodiment, the dry matter content of the texturized fish product is about 25% to about 60%.

The texturized fish product of the invention has a protein content of about 25% to about 90% based on dry matter of the texturized fish product. In another embodiment, the protein content is about 30% to about 45% based on dry matter. In a further embodiment, the protein content is about 35% to about 90% based on dry matter of the texturized fish product. In another embodiment, the protein content of the texturized fish product is about 40% to about 65% based on dry matter of the texturized fish product. In a further embodiment, the protein content of the texturized fish product is about 50% to about 60% based on dry matter of the texturized fish product. In a further embodiment, the protein content of the texturized fish product is about of about 25% to about 90% based on dry matter of the texturized fish product. In a still further embodiment, the protein content of the texturized fish product is about 30% to about 45% based on dry matter of the texturized fish product. When the fish feedstock containing a fish material does not comprise a plant-based food material, the protein content of the texturized fish product is typically about 70% to about 90% based on dry matter of the texturized fish product. When the fish feedstock containing a fish material further comprises a plant-based food material, the protein content of the texturized fish product is typically about 35% to about 65% based on dry matter of the texturized fish product.

The texturized fish product of the invention has a fish protein content of about 50% to about 100% based on the total protein content of the texturized fish product. In an embodiment, the fish protein content is about 60% to about 90%. In a further embodiment, the fish protein content is about 70% to about 80%.

The texturized fish product of the invention has a longitudinal tensile strength of about 3.5 kPa to about 10 kPa. In another embodiment, the longitudinal tensile strength is about 4.0 kPa to about 8.0 kPa.

The texturized fish product of the invention has a cross-sectional cutting force of about 2.0 N to about 5.0 N. In an embodiment, the cross-sectional cutting force is about 2.2 N to about 4.0 N.

In the following examples, the protein content of the texturized fish product was measured according to NMKL 6:2003, N×6.25. The moisture content was measured according to NMKL 23:1991.

The following examples are presented for further illustration of the invention without limiting the invention thereto.

### Example 1

A fish product of the invention was produced from the ingredients shown in Table 1. Gutted Baltic herring was used as a fish material.

TABLE 1

| | | | Protein (g)/100 g |
|---|---|---|---|
| Ingredients | Proportion (%) | Protein (%) | product |
| Fish material | 82.7 | 16.3 | 13.5 |
| Oat meal | 8.3 | 14.0 | 1.2 |
| Starch | 4.1 | 0.1 | 0.0 |
| Water | 4.1 | — | — |
| Plant extract | 0.1 | — | — |
| (natural colorant) | | | |
| Salt (NaCl) | 0.7 | — | — |
| Total | 100 | | 14.6 |

All ingredients were mixed and homogenized in a bowl cutter to a homogenous fish feedstock having an internal temperature of +7° C. The fish feedstock was pumped via feeding pipe into a texturizing apparatus, in which the fish feedstock was fed through an opening in the centre of the texturizing apparatus between heated stationary discs. The fish feedstock was transported between the discs by means of rotating paddles radially outwards to the periphery of the apparatus and finally discharged. The texturized fish product had an internal temperature of 80° C. The texturized fish product samples were manually collected from the discharge and cooled down in fridge to a room temperature.

The calculated protein content of the texturized fish product was 14.6%. The content of fish protein was 92.5% based on the total protein content of the texturized fish product.

FIG. 1 is a photograph of the texturized fish product produced by the above method. The figure shows that the method provides a texturized fish product exhibiting a cooked fish meat-like or cooked fish fillet-like texture.

### Example 2

A fish product of the invention was produced from the ingredients shown in Table 2. Gutted Baltic herring was used as a fish material.

TABLE 2

| | | | Protein (g)/100 g |
|---|---|---|---|
| Ingredients | Proportion (%) | Protein (%) | product |
| Fish material | 77.0 | 16.3 | 12.6 |
| Oat meal | 10.3 | 14.0 | 1.4 |
| Starch | 5.1 | 0.1 | — |
| Water | 3.1 | — | — |
| Vegetable powder | 2.1 | 7 | 0.1 |
| Spice mix | 1.3 | 4.8 | 0.1 |
| (including salt) | | | |
| Salt (NaCl) | 1.0 | — | — |
| Plant extract | 0.1 | — | — |
| (natural colorant) | | | |
| Total | 100 | | 14.2 |

All ingredients were mixed and homogenized in a bowl cutter to a homogenous fish feedstock having an internal temperature of +5° C. The fish feedstock was pumped via feeding pipe into a texturizing apparatus, in which the fish feedstock was fed through an opening in the centre of the texturizing apparatus between heated stationary discs. The fish feedstock was transported between the discs by means of rotating paddles radially outwards to the periphery of the apparatus and finally discharged at a inside temperature of 78° C. The texturized fish product samples were manually collected from the discharge, cooled down in room temperature, packed into plastic bags and frozen to −20° C. prior compositional analysis.

The dry matter of the texturized fish product was 34%. The calculated protein content of the texturized fish product was 14.2%. The protein content of the texturized fish product was 41.8% on dry matter basis. The content of fish protein was 88.7% based on the total protein content of the texturized fish product.

### Example 3

A fish product of the invention was produced from the ingredients shown in Table 3. Gutted Baltic herring was used as a fish material.

The calculated protein content of the texturized fish product was 14.6%. The content of fish protein was 91.8% based on the total protein content of the texturized fish product.

TABLE 3

| | | | Protein (g)/100 g |
|---|---|---|---|
| Ingredients | Proportion (%) | Protein (%) | product |
| Fish material | 81.9 | 16.3 | 13.4 |
| Oat meal | 8.2 | 14.0 | 1.1 |
| Starch | 4.1 | 0.1 | — |
| Water | 2.5 | — | — |
| Vegetable powder | 2.0 | 7 | 0.1 |
| Spice mix | 0.8 | 4.8 | — |
| (including salt) | | | |
| Salt (NaCl) | 0.4 | — | — |
| Plant extract | 0.1 | — | — |
| (natural colorant) | | | |
| Total | 100 | | 14.6 |

All ingredients were mixed and homogenized in a bowl cutter to a homogenous fish feedstock having an internal temperature of +3° C. The fish feedstock was pumped via feeding pipe and a scraped surface heat exchanger (with hot water circulation in a jacket) into a texturizing apparatus, in which the fish feedstock was fed through an opening in the centre of the texturizing apparatus between heated stationary discs. The fish feedstock was transported between the discs by means of rotating paddles radially outwards to the periphery of the apparatus and finally discharged on collection belt.

The scraped surface heat exchanger was used to control the internal temperature of the fish feedstock fed to the texturizing process by controlling the hot water circulation in the heat exchanger jacket. The fish feedstock temperature was measured after each water circulation adjustment from the pipe between the heat exchanger and the apparatus.

Internal temperatures of the fish feedstocks fed to the apparatus were as follows:

$$Sample 1 / + 5 ° C .$$

$$Sample 2 / + 15 ° C .$$

$$Sample 3 / + 27 ° C .$$

The texturized fish product samples 1-3 were manually collected from the collection belt and the internal temperature of the samples was monitored regularly. Internal temperatures remained between 75° C. and 90° C. The samples were cooled down in room temperature and packed in plastic bags on a flat surface and frozen to −20° C. temperature prior to textural analysis.

Tensile strength in longitudinal direction of the texturized fish product of the invention was measured according to a method as follows: The samples 1-3 were thawed in a fridge for 6 hours until they were fully melted. The samples were cut into 50 mm×16 mm pieces which were 50 mm long in the fish sample's longitudinal direction (direction containing more parallel fibrous areas, see FIG. 2). The samples were placed on petri dishes which were sealed with tape to prevent moisture loss. The samples were stored in a fridge overnight after cutting. Tensile strength was measured using Lloyd LS5 material testing device equipped with a static load cell (1000 N) (Ametek Inc., USA). The cut pieces were set between the jaws and teared to opposite directions with a test speed of 2 mm/s until breaking point was reached. Tensile strength was performed as 6 parallel measurements from each sample to longitudinal direction. Tensile strength values were normalized with parallel samples' cross-sectional area (width×thickness).

Cross-sectional cutting force of the texturized fish product of the invention was measured according to a method as follows: The samples 1-3 were thawed in a fridge for 6 hours until they were fully melted. The samples were cut into 16 mm×16 mm pieces and placed on a petri dish with an arrow showing the longitudinal direction of the square shaped samples to ensure that the samples would be measured in correct directions the next day. The petri dishes were sealed with tape to prevent moisture loss. The samples were stored in a fridge overnight after cutting. On the day of the measurements all the samples for every measurement were kept in room temperature for two hours to ensure that the samples were the same temperature before measuring. Cutting forces were measured from the samples with a Texture Analyser (TA.XTplus, Stable Micro Systems Ltd., UK). Cutting force was measured with a knife blade (HDP/BS) cross-sectionally (FIG. 2). The test speed was set to 2 mm/s, and the force required to fracture the sample (i.e., peak force of first peak) was determined for 10 replicate samples.

The average results of the textural analysis are shown in Table 4.

TABLE 4

| Measured feature | Sample 1 | Sample 2 | Sample 3 |
|---|---|---|---|
| Tensile strength (kPa) | 4.7 | 2.9 | 2.8 |
| Cutting force (N) | 2.4 | 2.1 | 1.5 |

The results show that the highest longitudinal tensile strength and the highest cross-sectional cutting force of the texturized fish product are obtained at the lowest internal temperature of the fish feedstock. The tensile strength and the cutting force decrease with the increased internal temperature of the fish feedstock. The results show that texturization of the fish feedstock becomes more difficult when the internal temperature of the feedstock increases. The higher the tensile strength and cutting force values are, the more the fish product is in texturized form. Longitudinal tensile strength indicates the elasticity and chewiness of the texturized structure as the cross-sectional cutting force indicates the bite resistance. Both indicators are essential in providing the fish meat or fish-fillet like mouthfeel for texturized fish product. FIG. 2 shows that the texturized fish produced from sample 1 exhibited a fish fillet-like texture.

The tactile texture and mouthfeel attribute intensities of the texturized fish product samples 1-3 were evaluated with generic descriptive analysis following standard sensory practices such as sample coding with 3-digit codes. For sensory profiling, texturized fish product samples were cut into 50 mm×15 mm pieces and 40 mm×15 mm pieces longitudinally (FIG. 2). The longer piece was used for analyzing the samples by touching and looking. The shorter piece was used for analyzing the sample by biting and chewing. The shorter pieces were warmed in microwave (700 W) on a covered plate for 30 seconds and then placed in plastic containers with lid. The panel consisted of eight trained assessors and the attribute list (attribute names, their descriptions, reference products and their intensities on 0-10 line scales) was created by the panel during consensus training sessions prior actual main evaluation of the samples.

Averages of the evaluated intensities of most relevant attributes on texture and mouthfeel from sensory analysis are presented in Table 5.

TABLE 5

| Sensory attribute | Sample 1 | Sample 2 | Sample 3 |
|---|---|---|---|
| Tearing distance (tactile texture) | 4.5 | 3.5 | 3.2 |
| Stickiness (tactile texture) | 2.8 | 3.0 | 4.2 |
| Biting resistance (mouthfeel) | 5.0 | 3.9 | 3.7 |
| Hardness (mouthfeel) | 4.9 | 3.6 | 2.9 |
| Residual structure (mouthfeel) | 4.6 | 4.3 | 2.9 |

Sample 1 was characterized by high tearing distance, high biting resistance, and the higher effort required to deform it by pressing the sample against the soft palate (Hardness, Table 5). Sample 3 was the stickiest and had least structure left after chewing. Sample 2 was found intermediate in its properties with some attributes closer to sample 1, and in other attributes closer to sample 3. Overall, the results of sensory analysis are consistent with the results of textural analysis and demonstrates how the complete texturization of sample 1 directly contributes positively to the texturized fish product's tactile texture (i.e. resilience in further processing and home cooking) and mouthfeel.

### Example 4

A fish product of the invention was produced from the ingredients shown in Table 6. Gutted mackerels were used as a fish material.

TABLE 6

| Ingredients | Proportion (%) |
|---|---|
| Fish material | 89.3 |
| Gluten-free oat meal | 2.6 |
| Starch | 5.1 |
| Plant fibre | 0.9 |
| Other minor compounds | 1.6 |
| and seasonings | |
| Salt (NaCl) | 0.5 |
| Total | 100 |

All ingredients were mixed and homogenized in a bowl cutter to a homogenous fish feedstock at a temperature of 13° C. The fish feedstock was pumped via feeding pipe into a texturizing apparatus, in which the fish feedstock was fed through an opening in the centre of the texturizing apparatus between heated stationary discs. The fish feedstock was transported between the discs by means of rotating paddles radially outwards to the periphery of the apparatus and finally discharged. The texturized fish product had an internal temperature of 85° C. The texturized fish product samples were manually collected from the discharge and cooled down in fridge to a room temperature.

FIG. 3 is a photograph of the texturized fish product produced by the above method. The figure shows that the method provides a texturized fish product exhibiting a cooked fish meat-like or cooked fish fillet-like texture containing areas with parallel longitudinal fish meat strips. In addition, the texturized fish product was gluten-free and free from soy.

Similar results were obtained with the recipe and process above when mackerel was replaced with whitefish or small vendace.

### Example 5

A fish product of the invention was produced from the ingredients shown in Table 7. By-products from filleting process of salmonoids (backbones, heads, ribs, trimmings) were used as fish material.

TABLE 7

| Ingredients | Proportion (%) |
|---|---|
| Fish material | 89 |
| Gluten-free oat meal | 2.5 |
| Starch | 5.0 |
| Plant fibre | 0.9 |
| Other minor compounds and | 1.6 |
| seasonings | |
| Salt (NaCl) | 1.0 |
| Total | 100 |

All ingredients were mixed and homogenized in a bowl cutter to a homogenous fish feedstock having an internal temperature of 7° C. The fish feedstock was pumped via feeding pipe into a texturizing apparatus, in which the fish feedstock was fed through an opening in the centre of the texturizing apparatus between heated stationary discs. The fish feedstock was transported between the discs by means of rotating paddles radially outwards to the periphery of the apparatus and finally discharged. The texturized fish product had an internal temperature between 82-87° C. The texturized fish product samples were manually collected from the discharge, cooled down in fridge to a room temperature and used for photographing.

The texturized fish product was gluten-free and free from soy.

FIG. 4 is a photograph of the texturized fish product produced by the above method. The figure shows that the method provides a texturized fish product exhibiting a cooked fish meat-like or cooked fish fillet-like texture containing areas with parallel longitudinal fish meat strips.

### Example 6

A fish product of the invention was produced from the ingredients shown in Table 8. Backbones obtained from filleting process (i.e., carcasses containing residual meat) of salmonoids were used as a fish material in the recipe.

TABLE 8

| Ingredients | Proportion (%) |
|---|---|
| Fish material | 97 |
| Plant fibre | 1.0 |
| Other minor compounds and | 1.4 |
| seasonings | |
| Salt (NaCl) | 0.6 |
| Total | 100 |

All ingredients were mixed and homogenized in a bowl cutter to homogenous fish feedstock having an internal temperature of 12° C. The fish feedstock was pumped via feeding pipe into a texturizing apparatus, in which the fish feedstock was fed through an opening in the centre of the texturizing apparatus between heated stationary discs. The fish feedstock was transported between the discs by means of rotating paddles radially outwards to the periphery of the apparatus and finally discharged. The texturized fish product had an internal temperature between 80-85° C. The texturized fish product sample was manually collected from the discharge and cooled down in fridge to a room temperature and photographed.

The analyzed protein content of the texturized fish product was 15.8% and the dry matter content 46.9%. The calculated content of fish protein was over 99% based on the total protein content of the texturized fish product.

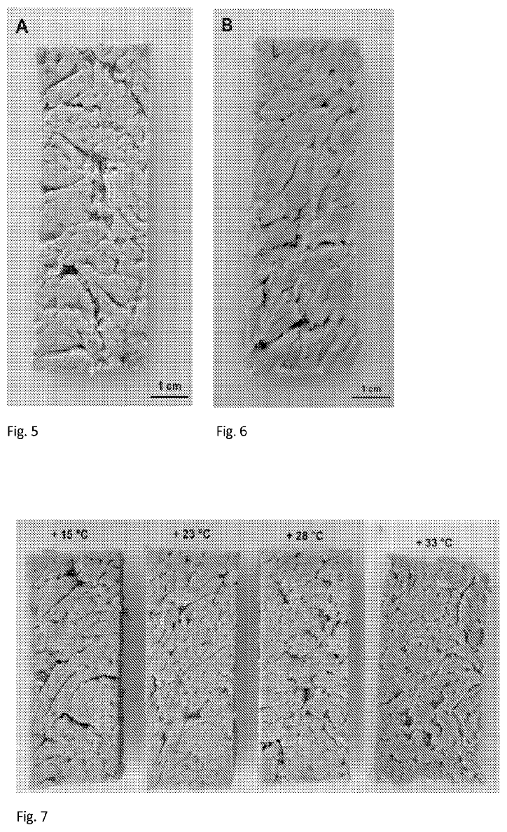

FIG. 5 (sample A) is a photograph of the texturized fish product produced by the above method. The figure shows that the texturized fish product exhibited a cooked fish meat-like or cooked fish fillet-like texture containing areas of parallel longitudinal fish meat strips. However, the longitudinal alignment was weaker compared with the texturized fish product in FIG. 4 that contained more plant-based materials. This shows that inclusion of plant-based ingredients in the manufacture of the texturized fish product can enhance the alignment and formation of areas with parallel longitudinal fish meat strips.

### Example 7

A fish product of the invention was produced from the ingredients shown in Table 9 in the same manner as described in example 6. Backbones obtained from filleting process (i.e., carcasses containing residual meat) of salmonoids was used as a fish material in the recipe.

TABLE 9

| Ingredients | Proportion (%) |
|---|---|
| Fish material | 75.5 |
| Pea protein | 7.6 |
| Water | 7.6 |
| Gluten-free oat meal | 2.1 |
| Starch | 4.3 |
| Plant fibre | 0.8 |
| Other minor compounds and | 1.5 |
| seasonings | |
| Salt (NaCl) | 0.6 |
| Total | 100 |

The analyzed protein content of the texturized fish product was 17.7% and dry matter content 47.7%. The calculated content of fish protein was 64.6% based on the total protein content of the texturized fish product.

FIG. 6 (sample B) is a photograph of the texturized fish product produced by the above method. The figure shows that the texturized fish product exhibited a cooked fish meat-like or cooked fish fillet-like texture. Despite the additional plant protein in the recipe, the texture was similar compared with the texturized fish product in FIG. 4.

### Example 8

A fish product of the invention was produced from the ingredients shown in Table 10. Backbones obtained from filleting process (i.e., carcasses containing residual meat) of salmonoids were used as a fish material.

TABLE 10

| Ingredients | Proportion (%) |
|---|---|
| Fish material | 89 |
| Glute-free oat meal | 2.5 |
| Starch | 5.1 |
| Plant fibre | 0.9 |
| Other minor compounds and | 1.5 |
| seasonings | |
| Salt (NaCl) | 1.0 |
| Total | 100 |

All ingredients were mixed and homogenized in a bowl cutter into four different homogenous fish feedstocks at internal temperatures of 15° C., 23° C., 28° C. and 33° C. The fish feedstocks were pumped via feeding pipe into a texturizing apparatus, in which the fish feedstocks were fed through an opening in the centre of the texturizing apparatus between heated stationary discs. The fish feedstocks were transported between the discs by means of rotating paddles radially outwards to the periphery of the apparatus and finally discharged. The texturized fish products had internal temperatures between 85-95° C. The texturized fish product samples were manually collected from the discharge and cooled down in fridge to a room temperature, cut to similar pieces and photographed.

FIG. 7 is a photograph of the texturized fish product samples from four fish feedstocks having said different internal temperatures prior to texturization. The figure shows that good texturization and cooked fish fillet-like structure was obtained with fish feedstocks having internal temperatures of 15° C. and 23° C. In addition, the texturized structure was still obtained (although with slightly weaker alignment) with a feedstock having an internal temperature of 28° C. The product obtained from fish feedstock having an internal temperature of 33° C. exhibited texturization with weak longitudinal alignment. However, the texture and mouthfeel were still considered acceptable.

### Example 9

A fish product of the invention was produced from the ingredients shown in Table 11. Backbones obtained from filleting process (i.e., carcasses containing residual meat) of salmonoids were used as a fish material.

TABLE 11

| Ingredients | Proportion (%) |
|---|---|
| Fish material | 88.1 |
| Gluten-free oat meal | 2.5 |
| Starch | 5.0 |
| Plant fibre | 0.9 |
| Other minor compounds and | 2.9 |
| seasonings | |
| Salt (NaCl) | 0.6 |
| Total | 100 |

All ingredients were mixed and homogenized in a bowl cutter to a homogenous fish feedstock with a temperature of 13° C. The fish feedstock was texturized and cooked as described in Example 1. The texturized fish product had an internal temperature between 80-85° C. The texturized fish product samples were manually collected from the discharge, cooled down in fridge to a room temperature and used for photographing and compositional analysis.

The analyzed protein content of the texturized fish product was 14.7% and the moisture content was 50.8%. The analyzed protein content of the texturized fish product was 29.9% based on the dry matter of the texturized fish product. The calculated content of fish protein was 95.2% based on the total protein content of the texturized fish product.

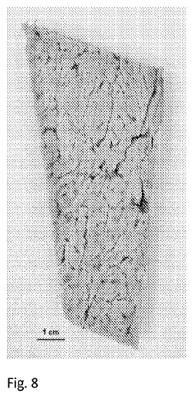

FIG. 8 is a photograph of the texturized fish product produced by the above method. The figure shows that the method provides a texturized fish product exhibiting a cooked fish meat-like or cooked fish fillet-like texture containing areas with parallel longitudinal fish meat layers.

It will be obvious to a person skilled in the art that, as the technology advances, the inventive concept can be implemented in various ways. The invention and its embodiments are not limited to the examples described above but may vary within the scope of the claims.

1.-37. (canceled)

38. A method of producing a texturized fish product, comprising the steps of:
providing a fish material,
optionally providing a plant-based food material,
deriving a fish feedstock from the fish material,
subjecting the fish feedstock to a texturizing step at most 100° C. to provide a texturized fish product having a protein content of about 10% to about 25%, specifically about 12% to about 20%, more specifically about 14% to about 17% based on the weight of the texturized fish product.

39. The method of claim 38, wherein the fish material is whole fish or gutted fish comprising at least one of fish bones, skin, fins, heads, and scale.

40. The method of claim 38, wherein the fish feedstock contains at least 50%, specifically about 55% to about 90%, more specifically about 65% to about 85%, more specifically about 55% to about 98%, still more specifically about 75% to about 85%, still more specifically about 65% to about 90%, still more specifically about 70% to about 95%, of the fish material.

41. The method of claim 38, wherein the fish feedstock contains at most 50%, specifically about 10% to about 45%, more specifically about 15% to about 35%, still more specifically about 2% to about 45%, still more specifically about 15% to about 25%, still more specifically about 10% to about 35%, still more specifically about 5% to about 30%, of the plant-based food material.

42. The method of claim 38, wherein the fish feedstock has a dry matter content of about 20% to about 50%, specifically about 30% to about 40%, more specifically about 25% to about 60%.

43. The method of claim 38, wherein the texturizing step is performed at a temperature between about 0° C. to about 95° C., specifically about 0° C. to about 90° C., more specifically between about 3° C. and about 85° C., still more specifically between about 5° C. to about 75° C.

44. The method of claim 38, wherein the texturizing step is performed at an atmospheric pressure.

45. The method of claim 38, wherein the texturizing step comprises heating a fish feedstock between two heated surfaces.

46. The method of claim 38, wherein the texturized fish product has at least one of the following: a longitudinal tensile strength of about 3.5 kPa to about 10 kPa, specifically about 4.0 kPa to about 8.0 kPa and a cross-sectional cutting force of about 2.0 N to about 5.0 N, specifically about 2.2 N to about 4.0 N.

47. The method of claim 38, wherein the texturizing step provides a texturized cooked fish product exhibiting longitudinal parallel fish meat strips and cooked fish fillet-like texture.

48. The method of claim 38, wherein texturized fish product has a protein content of about 25% to about 90%, specifically about 30% to about 45%, more specifically about 35% to about 90%, still more specifically about 40% to about 65%, still more specifically about 50% to about 60%, based on dry matter of the texturized fish product.

49. The method of claim 38, wherein the texturized fish product has a fish protein content of about 50% to about 100%, specifically about 60% to about 90%, more specifically about 70% to about 80% based on the total protein content of the texturized fish product.

50. A texturized fish product comprising a texturized fish material and having a protein content of about 10% to about 25% based on the weight of the texturized fish product.

51. The texturized fish product of claim 50, wherein the texturized fish product comprises at least 50%, specifically about 55% to about 90%, more specifically about 65% to about 85%, %, still more specifically about 55% to about 98%, still more specifically about 75% to about 85%, still more specifically about 65% to about 90%, still more specifically about 70% to about 95%, of the texturized fish material, based on the weight of the texturized fish product.

52. The texturized fish product of claim 50, wherein the texturized fish product comprises a plant-based food material of at most 50%, specifically about 10% to about 45%, more specifically about 15% to about 35%, %, still more specifically about 2% to about 45%, still more specifically about 15% to about 25%, still more specifically about 10% to about 35%, still more specifically about 5% to about 30%, based on the weight of the texturized fish product.

53. The texturized fish product of claim 50, wherein the texturized fish product has a dry matter content of about 20% to about 50%, specifically about 30% to about 40%, more specifically about 25% to about 60%.

54. The texturized fish product of claim 50, wherein the texturized fish product has a protein content of about 25% to about 90%, specifically about 30% to about 45%, more specifically about 35% to about 90%, still more specifically about 40% to about 65%, still more specifically about 50% to about 60%, based on dry matter of the texturized fish product.

55. The texturized fish product of claim 50, wherein the texturized fish product has a fish protein content of about 50% to about 100%, specifically about 60% to about 90%, more specifically about 70% to about 80% based on the total protein content of the texturized fish product.

56. The texturized fish product of claim 50, wherein the texturized fish product has at least one of the following: a longitudinal tensile strength of about 3.5 kPa to about 10 kPa, specifically about 4.0 kPa to about 8.0 kPa,
a cross-sectional cutting force of about 2.0 N to about 5.0 N, specifically about 2.2 N to about 4.0 N.

57. The texturized fish product of claim 50, wherein the texturized fish product is a texturized cooked fish product exhibiting a longitudinal fish fillet-like texture.
